(19) United States
(12) Patent Application Publication
(10) Pub. No.: US 2025/0073780 A1
(43) Pub. Date: Mar. 6, 2025

(54) SENSOR FUSION WITH EDDY CURRENT SENSING

(71) Applicant: Divergent Technologies, Inc., Los Angeles, CA (US)

(72) Inventors: Farzaneh KAJI, Lomita, CA (US); Seyedalireza Torbatisarraf, Los Angeles, CA (US); Michael Thomas Kenworthy, Rancho Palos Verdes, CA (US)

(21) Appl. No.: 18/818,228

(22) Filed: Aug. 28, 2024

Related U.S. Application Data
(60) Provisional application No. 63/601,668, filed on Nov. 21, 2023.
(60) Provisional application No. 63/579,260, filed on Aug. 28, 2023.

(51) Int. Cl. B22F 10/37; B22F 10/85; B22F 12/90; B33Y 40/00; B33Y 50/02; G01N 21/01; G01N 21/88; G01N 21/89; G01N 21/892

(52) U.S. Cl. CPC B22F 10/37; B22F 10/85; B22F 12/90; B33Y 40/00; B33Y 50/02; G01N 21/01; G01N 21/8851; G01N 21/8914; G01N 21/892; G01N 2021/0125; G01N 2021/0181; G01N 2021/8887

(57) ABSTRACT

Systems and methods for powder bed additive manufacturing can include sensing a powder bed with an eddy current (EC) sensor to obtain an EC sensor measurement, sensing the powder bed with a secondary sensor to obtain a topographical measurement, and determining a property in the powder bed based on the EC sensor measurement and the topographical measurement.

### CROSS-REFERENCE TO RELATED APPLICATIONS

The present disclosure claims the benefit under 35 U.S.C. 119 of U.S. Provisional Patent Application No. 63/579,260, filed Aug. 28, 2023, and titled “SENSOR FUSION WITH EDDY CURRENT FOR IN-SITU MONITORING” and U.S. Provisional Patent Application No. 63/601,668, filed Nov. 21, 2023, and titled “SENSOR FUSION WITH EDDY CURRENT, ON-AXIS PHOTODIODE AND IR CAMERA” which applications are incorporated by reference herein in their entirety.

### BACKGROUND

### Field

The present disclosure relates generally to additive manufacturing, and more specifically to sensor fusion with eddy current sensors, on-axis photodiode sensors, and infrared cameras.

### Description of the Related Technology

Additive manufacturing process can include the use of powder bed fusion (PBF) systems that utilize a powder material source and a set of energy sources, most often high energy lasers, to selectively fuse the powder material into at least one build piece. The lasers melt the powder layer by layer to create the build pieces, which ultimately are solid objects. In operation, a recoater distributes a prescribed layer of powder over a built platform in a powder bed. The laser is then directed at a selected location and activated in order to sinter the powder at pre-defined locations on the layer. After completing sintering via laser melting of selected locations of the current layer, another layer of powder is applied via the recoater and the process is repeated until the build piece is complete.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

The systems, methods, and apparatuses described herein and their various aspects can enhance the ability of an additive manufacturing system to generate high quality build pieces using a plurality of sensors that are operable to monitor and/or measure characteristics of the powder bed, including surface and subsurface features.

Accordingly, in various aspects, incorporation of various non-contact sensors for monitoring characteristics such as reflectivity, thermal signatures, and voltage is described. One example of a non-contact sensor is an eddy current sensor with a fixed “stand-off” above the powder bed can be used in some aspects. Generally these eddy current sensors can be mounted on the recoater, the powder spreading mechanism, to achieve a desirable proximity to the powder bed, while also ensuring a proper and regular distance for consistent sensing. The quality of a powder spread can vary based on a number of key variables, including the type of alloy constituting the powder, particle size distribution, moisture content, recoater travel speed, and others.

In some aspects, technologies for characterizing the uniformity of the spread powder layer can include structured light scanning. This can be used to generate a detailed topographical map of the powder bed and can capture deviations from a nominal and/or average expected distribution.

An example aspect includes a method for determining height characteristics of a powder bed that is captured for each layer of a build process, providing for a quality understanding of topographical features of the powder bed using local stand-off distance measured by an eddy current sensor as a function of its position above the powder bed. Leveraging this data using correlation with at least one other type of sensor data can provide enhanced correction capability to improve the accuracy of knowledge of the topographical features to ensure high quality build pieces.

In another example aspect, sensitivity of the eddy current sensor to high temperatures and temperature variations due to changing impedance in the eddy current sensor impedance coil can be remedied by using an infrared camera to monitor the temperature of the powder bed in real time during an additive manufacturing build operation. Accordingly, powder bed temperature can be monitored using the infrared camera, and conductivity measurements captured by the eddy current sensor impedance coil can be adjusted as a function of or with respect to temperature at each location above the powder bed.

In another example aspect, an eddy current sensor is capable of “seeing through” a build piece to subsurface layers based on sensor size and sensitivity. Lack of fusion, streaking, lumps, and other defects that would not otherwise be detected by a photodiode, i.e., because a photodiode is only able to detect surface defects, may be detectable by an eddy current sensor. This may allow for healing of the lack of fusion defects at sub surface layers by re-melting selected locations of the build piece at higher layers that are closer to the surface.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

The detailed description set forth below in connection with the appended drawings is intended to provide a description of various exemplary aspects are not intended to represent the only aspects in which the disclosure may be practiced. The term “exemplary” used throughout this disclosure means “serving as an example, instance, or illustration,” and should not necessarily be construed as preferred or advantageous over other aspects presented in this disclosure. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which: FIG. 1A shows a PBF system after a slice of build piece has been fused, but before the next layer of powder has been deposited in accordance with an aspect of the present disclosure;

FIG. 1B shows a PBF system after a slice of build piece has been fused, but before the next layer of powder has been deposited in accordance with an aspect of the present disclosure;

FIG. 1C shows a PBF system at a stage in which a depositor is positioned to deposit powder in a space created over the top surfaces of a build piece and a powder bed bounded by powder bed receptacle walls in accordance with an aspect of the present disclose;

FIG. 1D shows a PBF system at a stage in which, following the deposition of powder layer, an energy source is fusing powder with a build piece in accordance with an aspect of the present disclosure;

FIG. 1E illustrates a functional block diagram of a 3-D printer system in accordance with an aspect of the present disclosure;

FIG. 2 is a diagram showing sensor fusion opportunity in accordance with an aspect of the present disclosure;

FIG. 3 is a diagram showing a data fusion step in accordance with an aspect of the present disclosure;

FIG. 4 is a diagram showing an eddy current sensor array over a powder bed with height variation in accordance with an aspect of the present disclosure;

FIG. 5 is a flowchart showing conversion of raw data to material data that can be used for AI/ML or other operations in accordance with an aspect of the present disclosure;

FIG. 6 is a diagram showing sensing of topography of a powder bed via a structural light system in accordance with an aspect of the present disclosure;

FIG. 7 is a diagram of sensor fusion in accordance with an aspect of the present disclosure;

FIG. 8 is a pair of diagrams showing an eddy current array and a powder bed without height variation and with height variation, respectively, in accordance with an aspect of the present disclosure;

FIG. 9 is a flowchart showing stand-off measurement variability for adjusting EC sensor readings in accordance with an aspect of the present disclosure;

FIG. 10 is a diagram showing sensing of temperature properties of a powder bed via an infrared camera for fusion with data from an EC sensor array in accordance with an aspect of the present disclosure;

FIG. 11 is a flowchart showing calibration of an EC sensor array based on temperature in accordance with an aspect of the present disclosure;

FIG. 12 is a diagram showing structural abilities of photodiodes and EC sensor arrays in accordance with an aspect of the present disclosure;

FIG. 13 is a flowchart showing correlative analysis between a photodiode signal and Lack of Fusion (LoF) porosity based on verification from the EC sensory array;

FIG. 14 is a flowchart showing a method of sensor fusion; and

FIG. 15 is a flowchart showing a method of sensor fusion.

### DETAILED DESCRIPTION

The detailed description set forth below in connection with the appended drawings is intended to provide a description of various exemplary aspects are not intended to represent the only aspects in which the disclosure may be practiced. The detailed description includes specific details for the purpose of providing a thorough and complete disclosure that fully conveys the scope of the disclosure to those of ordinary skill in the art. However, the techniques and approaches of the present disclosure may be practiced without these specific details. In some instances, well-known structures and components may be shown in block diagram form, or omitted entirely, in order to avoid obscuring the various concepts presented throughout this disclosure.

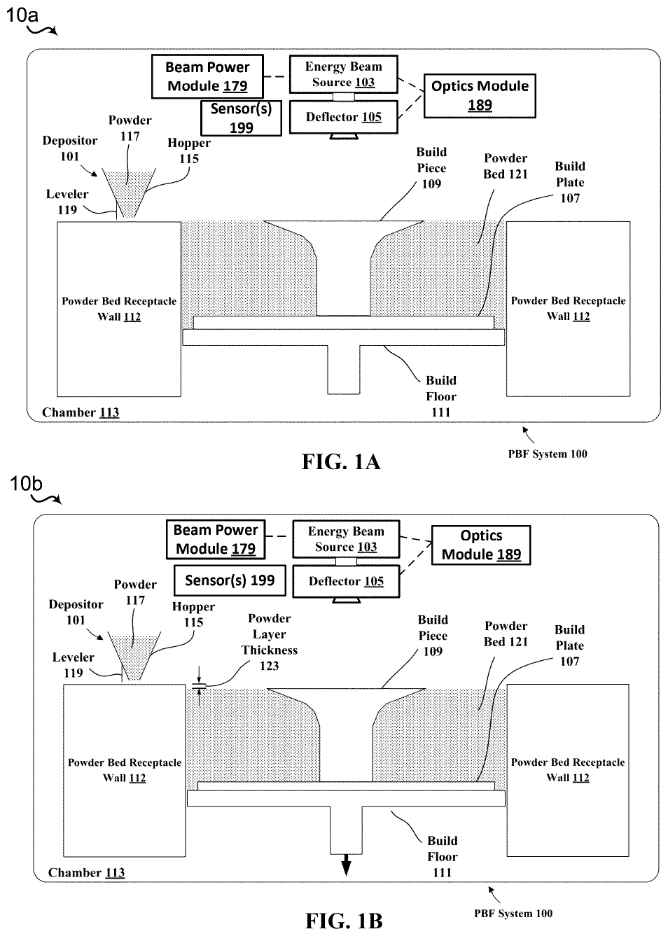

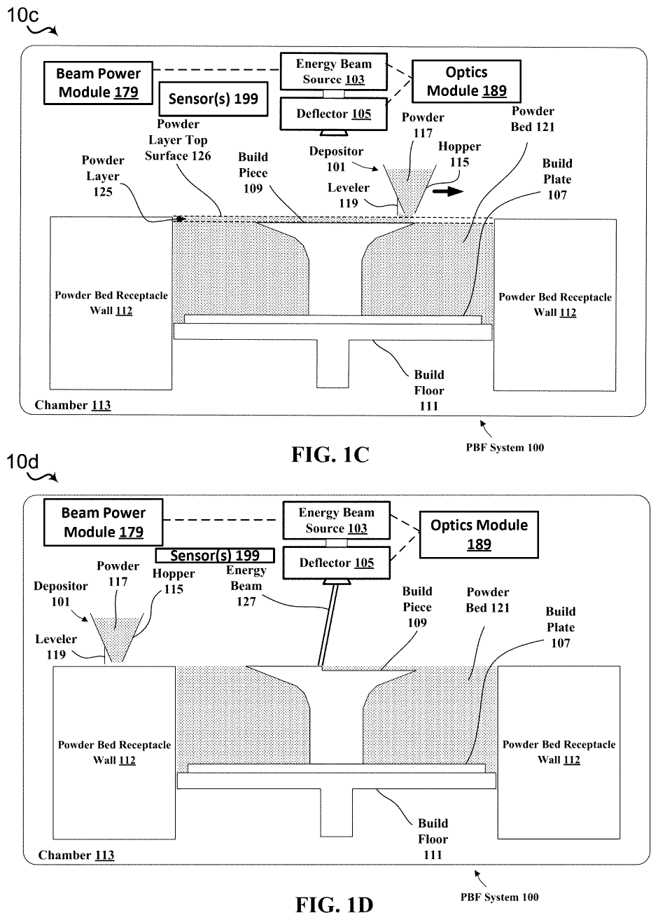

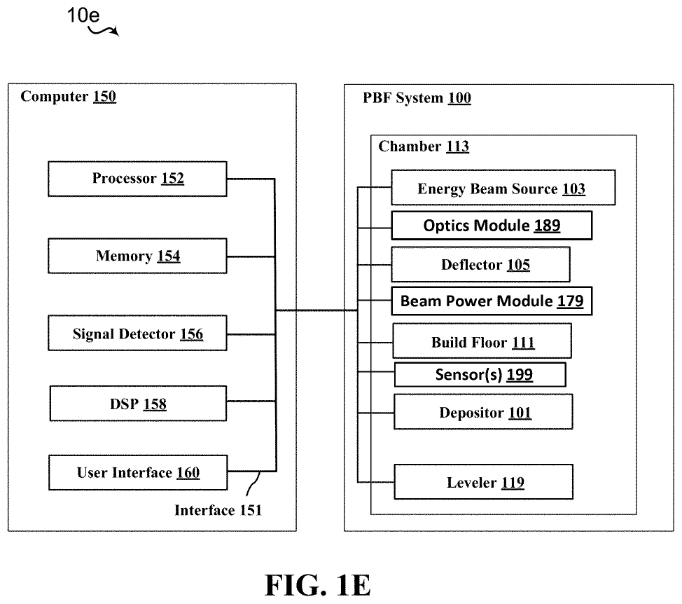

FIGS. 1A-D illustrate respective side views of an example 3-D printer system for a powder bed fusion build operation.

In this example, the 3-D printer system is a powder-bed fusion (PBF) system 100. FIGS. 1A-D show diagrams 10a-10d, respectively, of PBF system 100 during different stages of operation. The particular aspects illustrated in FIGS. 1A-D is one of many suitable examples of a PBF system employing principles providing some of the basis of this disclosure. It should also be noted that elements of FIGS. 1A-D and the other figures in this disclosure are not necessarily drawn to scale but may be drawn larger or smaller for the purpose of better illustration of concepts described herein.

PBF System 100 may be an electron-beam PBF system 100, a laser PBF system 100, or other type of PBF system 100. Further, other types of 3-D printing, such as Directed Energy Deposition, Selective Laser Melting, Binder Jet, etc., may be employed without departing from the scope of the present disclosure.

PBF system 100 can include a depositor 101 that can deposit each layer of powder from at least one powders 117, an energy beam source 103 that can generate an energy beam, a deflector 105 that can apply the energy beam to fuse the powder material, and a build plate 107 that can support at least one build pieces, such as a build piece 109. Although the terms “fuse” and/or “fusing” are used to describe the mechanical coupling of the powder particles, other mechanical actions, e.g., sintering, melting, and/or other electrical, mechanical, electromechanical, electrochemical, and/or chemical coupling methods are envisioned as being within the scope of and/or associated with various aspects of the present disclosure. In various embodiments, energy beam source 103 can include a multi-mode ring laser configured to generate multiple beams, e.g., a first beam (which may be a spot beam or a first ring beam) and a second ring beam surrounding the first beam. In various embodiments, the multi-mode ring laser may further be configured to generate beams of varying power (such as with a beam power module 179, described in more detail below) and/or adjust the beams with various optics to, e.g., magnify, zoom, etc. (such as with an optics module 189, described in more detail below). Although shown as individual components in FIGS. 1A-E, energy beam source 103, beam power module 179, and/or optics module 189 may be variously incorporated into a single component or two components as one skilled in the art would readily understand.

PBF system 100 can also include a build floor 111 positioned within a powder bed receptacle. The walls 112 of the powder bed receptacle generally define the boundaries of the powder bed receptacle, which is located between the walls 112 from the side and abuts a portion of the build floor 111 below. Build floor 111 can progressively lower build plate 107 so that depositor 101 can deposit a next layer. The entire mechanism may reside in a chamber 113 that can enclose the other components, thereby protecting the equipment, enabling atmospheric and temperature regulation mitigating contamination risks, and allowing for unused powder to be recycled. Depositor 101 can include at least one hopper 115. The at least one hopper 115 can contain the at least one powder 117, such as a metal powder, alloy, or other material. Depositor 101 can also include at least one leveler 119 that can level the top of each layer of deposited powder. Leveler 119 can be located in different locations in different aspects.

AM processes may produce the build object and may also produce various support structures that maintain structural integrity of the build object during AM processes. Support structures can be nonessential to the build object upon build object completion and may require removal to reduce weight, improve energy distribution, improve aesthetics, or for other beneficial reasons. The particular aspects illustrated in FIGS. 1A-D are some suitable examples of a PBF system with at least one hopper employing principles of the present disclosure. Specifically, support structures and interfaces between support structures and build objects that have characteristics that vary from characteristics of the build objects themselves described herein may be used in at least one PBF system 100 described in FIGS. 1A-D. Methods of selectively manufacturing various aspects according to desired outcomes are also disclosed herein. While at least one methods described in the present disclosure may be suitable for various AM processes (e.g., using a PBF system, as shown in FIGS. 1A-D), it will be appreciated that at least one methods of the present disclosure may be suitable for other applications, as well. For example, at least one methods described herein may be used in other fields or areas of manufacture without departing from the scope of the present disclosure. Accordingly, AM processes employing the at least one methods of the present disclosure are to be regarded as illustrative and are not intended to limit the scope of the present disclosure.

Referring specifically to FIG. 1A, this figure shows PBF system 100 after a slice of build piece 109 has been fused, but before the next layer of powder has been deposited. In fact, FIG. 1A illustrates a time at which PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

In various aspects such powder in powder bed 121 can be beneficially harvested, recaptured, and/or recycled for use in the same or other projects. This can reduce waste, cut costs, and provide other benefits.

FIG. 1B shows PBF system 100 at a stage in which build floor 111 can lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness substantially equal to the powder layer thickness 123 (see FIG. 1B) and exposing powder layer top surface 126. Thus, the powder in a PBF system can be supported by a powder material support structure, which can include, for example, a build plate 107, a build floor 111, a build piece 109, walls 112, and the like. It should be noted that the illustrated thickness of powder layer 125 (i.e., powder layer thickness 123 (FIG. 1B)) is greater than an actual thickness used for the example involving 150 previously deposited layers discussed herein with reference to FIG. 1A.

FIG. 1D shows PBF system 100 at a stage in which, following the deposition of powder layer 125 (FIG. 1C), energy beam source 103 generates at least one energy beam 127 and deflector 105 applies the energy beam to fuse the next slice in build piece 109. In various aspects, energy beam source 103 can be a laser, in which case energy beam 127 is a laser beam. Deflector 105 can include an optical system that uses reflection and/or refraction to manipulate the laser beam to scan selected areas to be fused. Although a single energy beam 127 is shown in FIGS. 1A-1D for simplicity and clarity, it should be understood from the present disclosure that at least one energy beams can and are selectively generated according to various aspects herein. Further description of such multi-beam configurations is proved in the present disclosure.

As shown in FIGS. 1A-1E, in various aspects, an optics module 189 can be communicatively coupled with energy beam source 103 and/or deflector 105. Optics module can include additional components that are configured to perform various actions and selectively generate various features. For example, magnification through optical means can be performed on energy beam 127 at energy beam source 103, deflector 105, or elsewhere, whereby a spot size of energy beam 127 is selectively manipulated to generate desired effects, such as increasing or decreasing the spot size. In such instances, optics module 189 can include, be integrated with, be coupled with, and/or control at least one optical components, such as at least one lenses, positioners, motors, gimbals, actuators, prisms, polarizers, filters, attenuators, reticles, and/or other components of optical systems as appropriate to generate a desired magnification or reduction of spot size. Optics module 189 can include at least one communications interface, memory, processor, and/or other components, as appropriate and/or required.

Also shown in FIGS. 1A-1E is a beam power module 179. In various aspects, ring mode lasers can be employed to introduce shaping of the energy beam 127 (i.e., beam-shaping), which can selectively generate desired effects at an application point where the energy beam spot is being applied to powder. Beam power module 179 can include at least one components configured to selectively modify and/or tune power delivery to and/or in energy beam source. In some aspects, beam power module 179 can be integrated with energy beam source 103, while in some aspects beam power module 179 can be self-contained or distributed elsewhere and communicatively coupled with energy beam source 103. Functionality of beam power module 179 is discussed in further detail herein. Beam power module 179 can include at least one communications interface, memory, processor, and/or other components, as appropriate and/or required.

Also shown in FIGS. 1A-1E is at least one sensor(s) 199. In various aspects, sensor(s) 199 can be employed to sense a region of material during an AM process. In various embodiments, sensor(s) 199 may include, e.g., at least a photodiode, an optical tomography (OT) camera, or an eddy current sensor.

In various aspects, the deflector 105 can include at least one gimbals and actuators that can rotate and/or translate the energy beam source to position the energy beam. In various aspects, energy beam source 103 and/or deflector 105 can modulate the energy beam, e.g., turn the energy beam on and off as the deflector scans so that the energy beam is applied only in the appropriate areas of the powder layer. For example, in various aspects, the energy beam can be modulated by a digital signal processor (DSP).

FIG. 1E illustrates a functional block diagram 10e of PBF system 100 in accordance with an aspect of the present disclosure. It should be noted that FIG. 1E shows some components that are not shown in FIGS. 1A-D for the sake of clarity.

In an aspect of the present disclosure, control devices and/or elements, including computer software, may be coupled to PBF system 100 to control at least one component within PBF system 100. Such a device may be a computer 150, which may include at least one component that may assist in the control of PBF system 100. Computer 150 may communicate with and/or be communicatively coupled with a PBF system 100, and/or other AM systems, via at least one wired and/or wireless interfaces 151. The computer 150 and/or interface 151 are examples of devices that may be configured to implement the various methods described herein, that may assist in controlling PBF system 100 and/or other AM systems.

In an aspect of the present disclosure, computer 150 may comprise at least one processor 152, memory 154, signal detector 156, a digital signal processor (DSP) 158, and at least one user interfaces 160. Computer 150 may include additional components without departing from the scope of the present disclosure.

Processor 152 may assist in the control and/or operation of PBF system 100. The processor 152 may also be referred to as a central processing unit (CPU). Memory 154, which may include both read-only memory (ROM) and random access memory (RAM), may store and provide instructions and/or data to the processor 152. A portion of the memory 154 may also include non-volatile random access memory (NVRAM). The processor 152 typically performs logical and arithmetic operations based on program instructions stored within the memory 154. The instructions in the memory 154 may be executable (by the processor 152, for example) to implement the methods described herein.

Processor 152 may comprise or be a component of a processing system implemented with at least one processor. The at least one processor may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that can perform calculations or other manipulations of information.

Processor 152 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the at least one processor, cause the processing system to perform the various functions described herein.

Signal detector 156 may be used to detect and quantify any level of signals received by the computer 150 for use by the processor 152 and/or other components of the computer 150. The signal detector 156 may detect such signals as energy beam source 103 power, deflector 105 position, build floor 111 height, amount of powder 117 remaining in depositor 101, location of depositor 101, location of nozzles for hopper 115, location of pixels and/or voxels, leveler 119 position, and other signals. DSP 158 may be used in processing signals received by the computer 150. The DSP 158 may be configured to generate instructions and/or packets of instructions for transmission to PBF system 100.

The user interface 160 may comprise a speaker, microphone, camera, sensor(s), keypad or keyboard, a pointing device, and/or a display that can be touchscreen in some aspects. The user interface 160 may include any element or component or combinations thereof that conveys information to a user of the computer 150 and/or receives input from the user.

The various components of the computer 150 may be coupled together by interface 151, which may include, e.g., a bus system. The interface 151 may include a data bus, for example, as well as a power bus, a control signal bus, and a status signal bus in addition to the data bus. Components of the computer 150 may be coupled together or accept or provide inputs to each other using some other mechanism.

Although a number of separate components are illustrated in FIG. 1E, at least one of the components may be combined or commonly implemented. For example, the processor 152 may be used to implement not only the functionality described herein with respect to the processor 152, but also to implement the functionality described herein with respect to the signal detector 156, the DSP 158, and/or the user interface 160. Further, each of the components illustrated in FIG. 1E may be implemented using a plurality of separate elements.

Also shown in FIG. 1E may include at least one sensor(s) 199. Sensor(s) 199 can include at least one sensor in some aspects. In various aspects, sensor(s) 199 can be configured as part of PBF system 100, as shown in FIG. 1E, or may be included in a separate component coupled to PBF system 100. In some aspects sensor(s) 199 can be located partially or wholly within chamber 113 and may be physically connected (e.g., mounted) and/or communicatively coupled with at least one other components of PBF system 100, depending on the functionality of a particular sensor and its use in the PBF system 100. Sensor(s) 199 can include at least an eddy current sensor, an eddy current sensor array, optical sensors, temperature sensors, movement sensors, audio sensors, chemical sensors, pressure sensors, weight sensors, distance sensors, proximity sensors, orientation sensors, velocity sensors, speed sensors, acceleration sensors, electromagnetic sensors, radiation sensors, humidity/moisture sensors, and/or others, as appropriate and/or required. Sensor(s) 199 can include at least one communications interface, as appropriate and/or required.

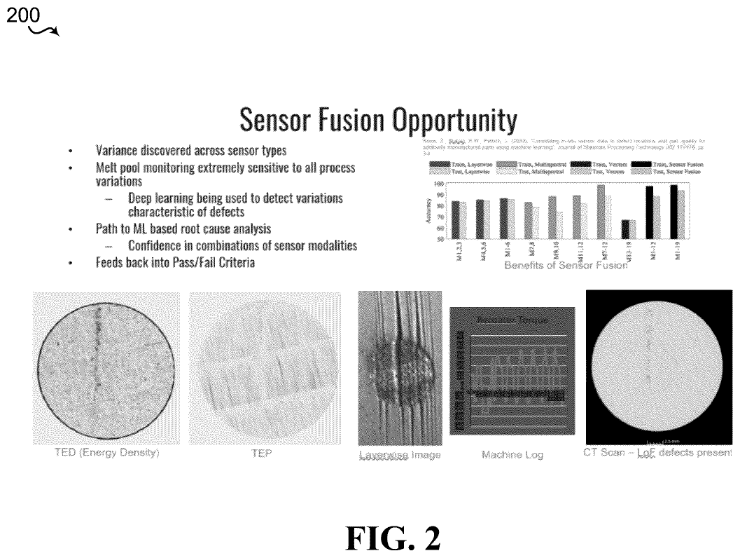

FIG. 2 is a diagram 200 showing sensor fusion opportunity. As shown, in various aspects variance can be discovered across at least one sensor types. Examples of sensor types include thermal energy density (TED), thermal energy Planck (TEP), Layerwise Image (which may include, e.g., optical imaging of the powder bed), Machine Log (which may include, e.g., data of various states, parameters, etc., of the 3D printer), CT Scan (which may include, e.g., CT scan data of build pieces), and/or others. In additive manufacturing, processes employing laser deposition techniques can use or employ at least one sensor in order to monitor a melt pool caused by directing and activating a laser toward at least one locations of a powder bed and/or build piece. Monitoring characteristics of a melt pool can be difficult due to the rapidly changing characteristics of the melt pool as the laser is applied to the powder bed and/or build piece. Characteristics monitored can include minute and localized changes in temperature, material changes, chemical processes, fluid dynamics, cavitation, and/or others. Accordingly, the at least one sensors may be finely tuned and highly sensitive in order to capture the rapidly changing characteristics of additive manufacturing processes. In many aspects, deep learning via artificial intelligence and/or machine learning (AI/ML) can be used to monitor and detect variation characteristics, which can be used to identify defects in a build piece that may require remedy in order to maintain structural integrity, comply with various parameters, and/or tolerances, and other relevant details. Accordingly, the sensor(s) and/or AI/ML can be employed in at least one feedback loops that further trains an AI/ML model in order to effectively chart a path to ML based root cause analysis of problems and/or issues. In some aspects, at least one pass/fail criteria can allow for the system to effectively complete highly detailed and/or complicated processes and builds.

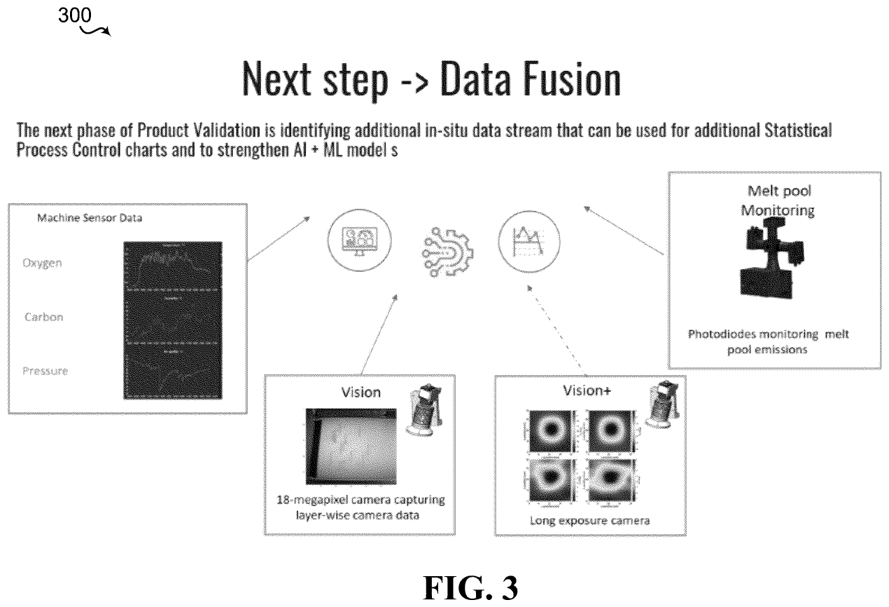

FIG. 3 is a diagram 300 showing a data fusion example. As shown, in various aspects a data fusion example can include identifying at least one in-situ data stream(s). In situ data streams can be used for at least one statistical process control charts. Additionally or alternatively, in situ data streams can be used with at least one AI/ML models. In situ data streams can be data streams that are created using sensor data that is captured by at least one sensor including temperature sensors, eddy current sensors, chemical sensors, visual sensors such as cameras, vision plus (vision+) sensors such as long exposure cameras, photodiodes, voltage sensors, impedance sensors, pressure sensors, proximity sensors, and others. Examples of machine sensor data streams can include oxygen level or concentration sensors, carbon level or concentration sensors, other element or chemical level or concentration sensors, pressure sensors, or others. An example of a vision sensor is an eighteen megapixel camera that captures layer-wise camera data. Photodiodes can be used to monitor melt pool electromagnetic (EM) emissions, e.g., thermal emissions. As each sensor senses data (e.g., in a data stream), the data can be captured in real-time and processed and/or stored in memory for later processing. Data streams can include reference information including timing information or timestamps and/or event markers. Various AI/ML components, systems, sub-systems, models, and/or algorithms can receive and/or access the data streams and use the data streams for training (e.g., model training); for gathering, developing, and/or strengthening insights (e.g., through correlation, where occurrence of an event can be measured and correlated with at least one parameters including temperature, light, voltage, or others) in order to predict future events and improve future additive manufacturing operations.

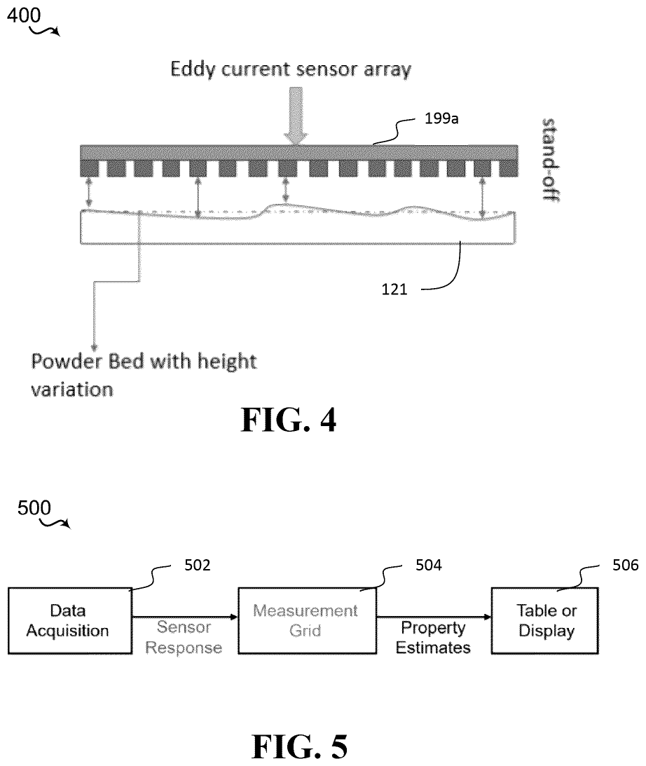

FIGS. 4-7 illustrate sensor fusion examples using an EC sensor measurement using an eddy-current sensor array.

FIG. 4 is a diagram 400 showing an example eddy current (EC) sensor array 199a over a powder bed 121 with height variation, according to various aspects. As shown, when powder is deposited in powder bed 121 it may not result in a perfectly uniform or flat surface or distribution. This uneven distribution of powder can result in a topography that includes various hills and valleys or troughs in the powder that is in powder bed 121. Uneven distribution of powder can cause localized differences in material fusion and may result in minute or even large variability in a build piece. This is important because in certain industries with high performance vehicles (e.g., automotive or aerospace), tolerances are required to be within a very narrow range in order to ensure safety, stability, and integrity of the vehicle (e.g., supercars, aircraft, or spacecraft). Fabrication of build pieces outside the acceptable tolerances for a build piece can result in the build piece needing to be scrapped or discarded, which wastes valuable resources including time and money. Use of a sensor array, such as EC sensor array 199a, provides benefits in that greater accuracy of measurements can be ensured as compared to single sensors or small numbers of sensors. In some aspects, EC sensor array 199a can detect anomalies, imperfections, or other deviations that can be remedied by the system using components for smoothing the upper surface of powder bed 121, depositing (or removing) powder from powder bed 121 to create a more uniform surface for fusion with or as a build piece, and for re-melting a build piece 109 when defects in the build piece 109 are detected.

FIG. 5 is a flowchart 500 showing conversion of raw data to material data that can be used for AI/ML or other operations. In block 502, data can be acquired. Data acquisition can include using at least one sensor 199 to sense powder bed 121 and/or build piece 109 height variation, temperature, voltage, impedance, and/or other properties and generate at least one data streams that can be used by the system. Data acquisition can cause a sensor response that leads to or results in development of a measurement grid in block 504. Measurement grid 504 can be a highly detailed grid of powder bed and/or build piece topography that can be processed and/or stored in memory for later processing. Measurement grid 504 can be processed in order to generate property estimates of at least one property of the powder bed and/or build piece 109 including height variation at various locations in the powder bed and/or build piece 109. These property estimates can be used to generate a table and/or displayed in visual form via a user interface display for the system and/or operator review can aid or assist in build piece development using the system.

In accordance with various aspects, impedance is a complex property with variable quantities including resistance, a real part, and reactance, an imaginary part. In practice, while an eddy current sensor array (e.g., EC sensory array 199a) measures voltage changes, these changes are indicative of alterations in impedance caused by interaction of the sensor with the powder and/or build piece in the powder bed material being analyzed. Impedance changes can be used to infer properties of the material, such as conductivity, defects, or variations in material composition.

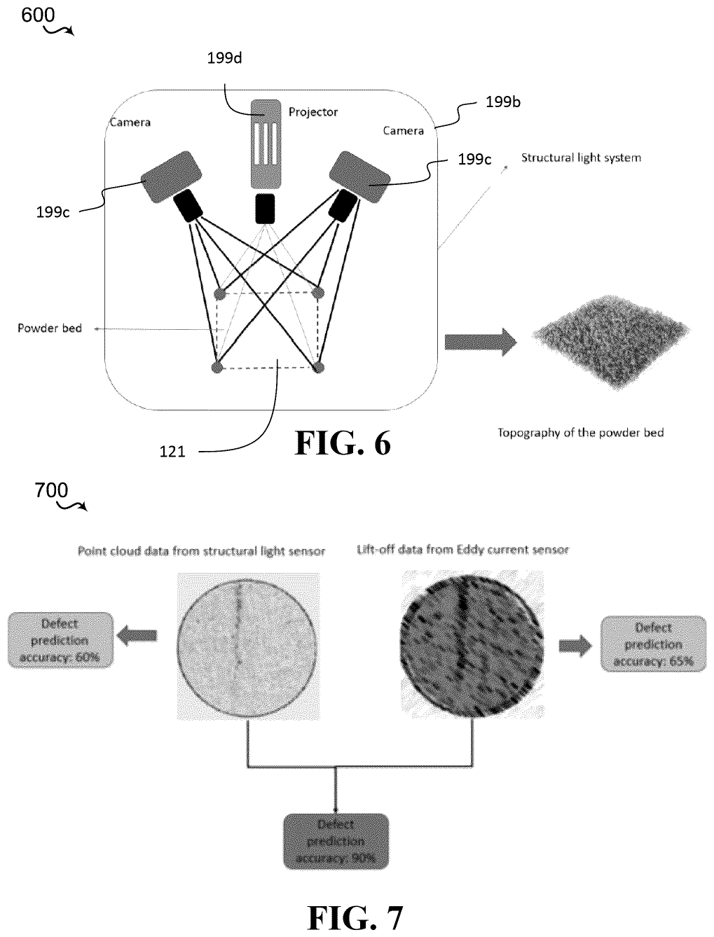

Once EC sensor array 199a traverses the powder bed (e.g., via at least one path controlled by at least one processor via motors and a gantry or other mechanical or electromechanical assembly), EC sensor measurements are acquired for each section of the powder bed and, eventually, for a selected portion of the powder bed or the entire powder bed. EC sensor measurement data in the form of a data stream can be combined or correlated with a topographical map (e.g., a point cloud) acquired using another sensor such as a structural light (see FIG. 6 and associated description herein). This combination and/or correlation can result in an improved confidence level of defect detection on the powder bed and/or build piece as compared to either the eddy current sensor array or structural light alone.

FIG. 6 is a diagram 600 showing sensing of topography of a powder bed and/or build piece via a structural light system 199b. A structural light system 199b can include a plurality of cameras 199c and a projector 199d, which operate in conjunction to measure topographical features of powder bed 121 and/or build piece 109. In operation, projector 199d can be directed at a selected location of powder bed 121 and/or build piece 109 and cameras 199c can capture reflectivity of the light from the surface of powder bed 121 and/or build piece 109, whereby topographical features of the surface can be determined according to light measurements.

In various aspects, the process of establishing relationships between anomalies identified by EC sensory array 199a and/or structural light system 199b involves the utilization of statistical analysis or AI/ML methodologies. Given the susceptibility of sensor data from EC sensory array 199a and/or structural light system 199b to fluctuate under static and even rapidly varying conditions resulting from fusing operations, the efficacy of correlations based on individual EC sensory array 199a and/or structural light system 199b individually may be constrained by relatively lower levels of accuracy. To address this limitation, a more robust approach can be employed using the various aspects described herein that involves amalgamating multiple sensor modalities, as described further with respect to FIG. 7. This integration serves to elevate the accuracy and reliability of predictive outcomes, thereby enhancing the overall confidence in the resulting predictions.

FIG. 7 is a diagram 700 of sensor fusion in accordance with an aspect of the present disclosure. As shown, EC sensor data measured by an EC sensor 199a alone can result in defect prediction accuracy of about 65%. Point cloud data measured by a structural light system 199b alone can result in defect prediction accuracy of about 60%. Combined EC sensor data measured by an EC sensor array 199a and structural light system 199b can result in defect prediction accuracy of about 90%. Thus, the combined data as the result of data fusion results in a significant increase in defect prediction and can thereby be used to generate a much better understanding of topographical features of a powder bed 121 and/or build piece 109. Data fusion can be accomplished by cross-referencing and/or correlating the data and using statistical and/or AI/ML process(es) to identify inaccuracies and/or missing data in either the EC sensor data or point cloud data alone.

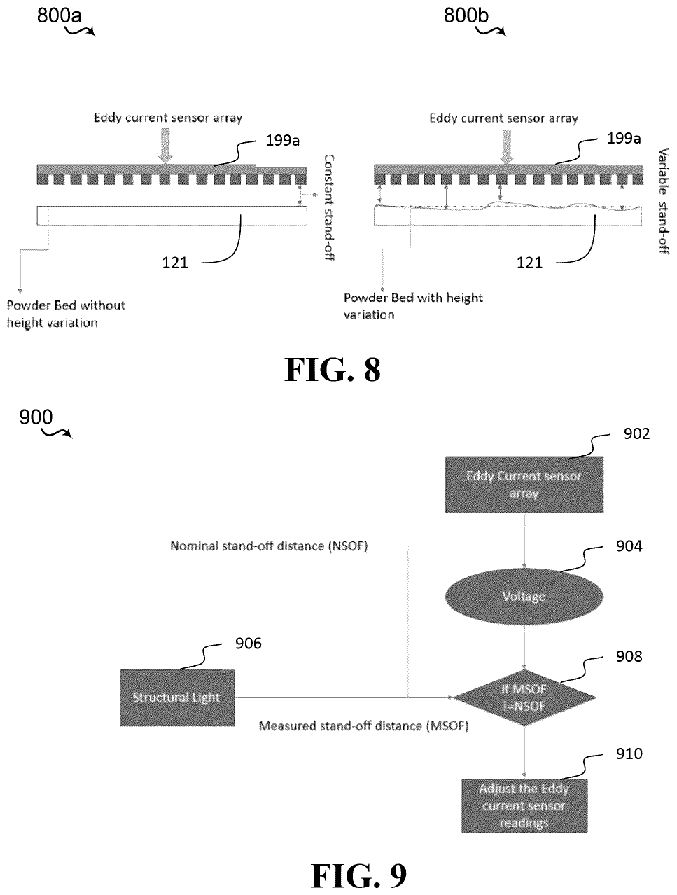

EC sensor invariance transformations for eddy current nondestructive evaluation signals will be described next with respect to FIGS. 8-9, which illustrate sensor fusion using stand-off measurements.

With regard to EC sensor distance management, one factor that affects the EC signal is EC sensor measurement. In practice, it can be difficult to track a value for EC sensor measurement, which can be used for accurately interpreting EC data. Therefore, according to various aspects it may be beneficial to have a scheme to render the EC data invariant to the effects of EC sensor measurement.

Calibration through topographical mapping can enhance the accuracy of EC sensor array output and a calibration procedure will now be detailed in accordance with various aspects. Calibration can be accomplished by utilizing topographical maps of a powder bed and/or build piece to correlate specific distance variations with voltage readings obtained by the EC sensor array 199a. By establishing a robust calibration model, uncertainties arising from stand-off distance fluctuations can be effectively compensated for and their negative effects can be minimized.

FIG. 8 is a pair of diagrams 800a, 800b showing an EC sensor array 199a and a powder bed 121 and/or build piece without height variation and with height variation, respectively. As shown in diagram 800a, according to various aspects an EC sensor array 199a over a powder bed 121 and/or build piece 109 without height variation (e.g., with uniform powder distribution height) can result in a constant stand-off measurement reading. As shown in diagram 800b, according to various aspects an EC sensor array 199a over a powder bed 121 and/or build piece 109 with height variation (e.g., without uniform powder distribution height) can result in a variable stand-off measurement reading.

FIG. 9 is a flowchart 900 showing stand-off measurement variability for adjusting EC sensor readings in accordance with an aspect of the present disclosure. As shown, in block 902 an EC sensor array (e.g., EC sensor array 199a) can be used to measure voltage in block 904. In block 906, structural light (e.g., structural light 199b) can sense and generate a measured stand-off distance (MSOF). This MSOF can be compared in with a nominal stand-off distance (NSOF). In block 908, if MSOF does not equal NSOF (e.g., exactly or within an acceptable selected or preset range of variability), EC sensor readings can be adjusted in block 910.

In some aspects, sensor fusion can be benefitted by measuring temperature of powder bed and/or build piece locations.

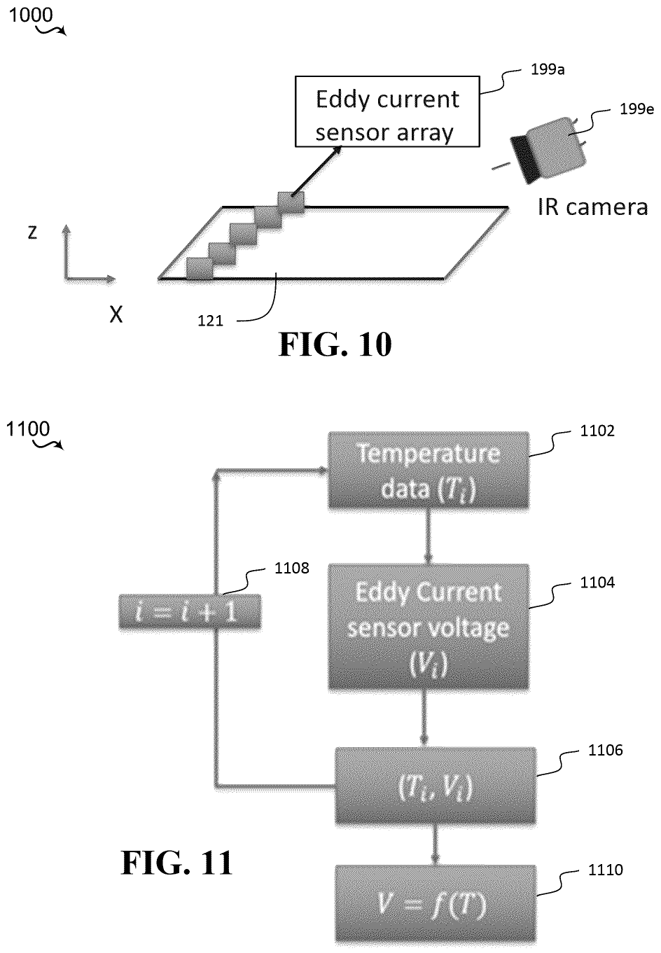

FIG. 10 is a diagram 1000 showing sensing of temperature properties of a powder bed 121 and/or build piece 109 via an infrared camera 199e for fusion with data from an EC sensor array 199a. As shown, an EC sensor array 199a can be used to measure properties of a powder bed and/or build piece as previously described herein. It can be beneficial to use an infrared (IR) camera 199e to measure temperature properties of powder bed 121 and/or build piece in selected locations, because temperature can be a variable that can affect measurements from EC sensor array 199a.

To elaborate, various non-contact sensors for monitoring thermal or other characteristics may be included. Although EC sensing via EC sensor array 199a can be used to solve transimpedance equations to calculate conductivity and EC sensor measurement, temperature variations in powder bed 121 and/or build piece 109 can adversely affect the accuracy of these heuristic techniques.

In practice, the sensitivity of an EC sensor array 199a to temperature is the result of changing impedance of the coil due to sensitivity to changes in temperature. Therefore, EC sensor arrays can be calibrated using IR camera 199e, which monitors the temperature of the powder bed and/or build piece in selected locations in real time.

FIG. 11 is a flowchart 1100 showing calibration of an EC sensor array based on temperature (e.g., as measured by an IR camera 199e). At block 1102, temperature data (Ti) can be measured. At block 1104 EC sensor array voltage (Vi) can be measured). This can result in a data set (Ti, Vi) in block 1106. In block 1108, the process can iterate (i=i+1) and return to block 1102. Also at block 1106, the data set (Ti, Vi) can proceed to block 1110 to be used to generate a function (V=f(T)) of sensor array voltage as a function of temperature, which can be used to calibrate the voltage readings of the eddy current sensor as a function of temperature.

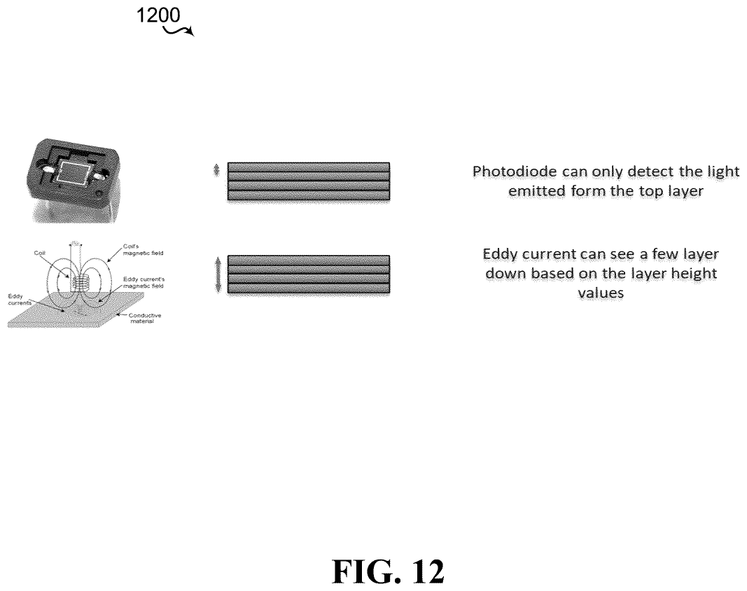

FIG. 12 is a diagram 1200 showing structural abilities of photodiodes and EC sensor arrays. As shown, a photodiode can be limited in its ability to sense conditions of a powder bed and/or build piece because a photodiode can only detect light emitted from a top or surface layer of a powder bed and/or build piece and not subsurface layers. An EC sensor array does not suffer from this limitation and can sense the surface layer as well as at least one subsurface layers of a powder bed and/or build piece based on layer height values.

Topographical data generated via measurements by the photodiode can be checked for accuracy and verified against measurements using EC sensor array 199a in at least one subsurface layers of the powder bed 121 and/or build piece 109. If inaccuracies in the topographical data measured by the photodiode are determined by the check against the measurements using EC sensor array 199a, these inaccuracies can be corrected in some aspects. For example, if topographical problems are determined to be a result of a lack of fusion (LoF), if LoF defects are healed then the topographical data from the photodiode can be corrected.

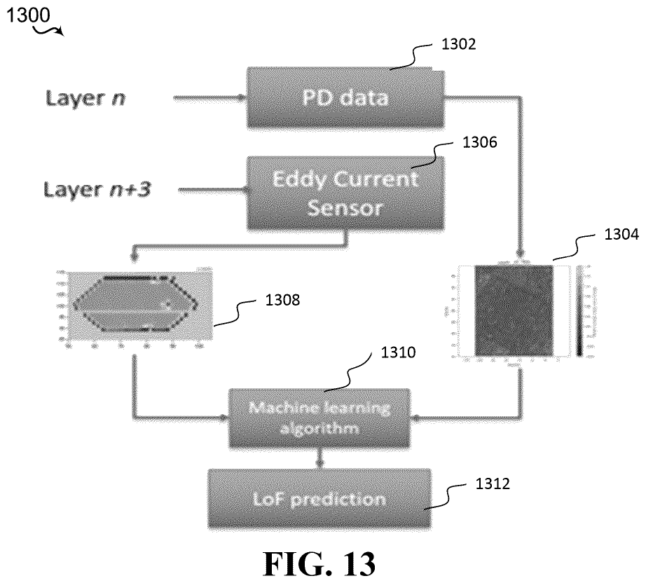

FIG. 13 is a flowchart 1300 showing correlative analysis between a photodiode signal and Lack of Fusion (LoF) porosity based on verification from the EC sensory array. As shown, for a layer n, where n represents a surface layer of a powder bed 121 and/or build piece 109, a block 1302 can include photodiode data measurements. These photodiode measurements can be used to generate a topographical map in block 1304. For a layer n+3 (i.e., a subsurface layer), a block 1306 can include EC sensor array data measurements. These EC sensor array data measurements can be used to generate a topographical map of at least one layer in block 1308. The topographical map of the surface layer from block 1304 and topographical map of at least one layer in block 1308 can be inputted into an AI/ML algorithm in block 1310, which can output a LoF prediction in block 1312.

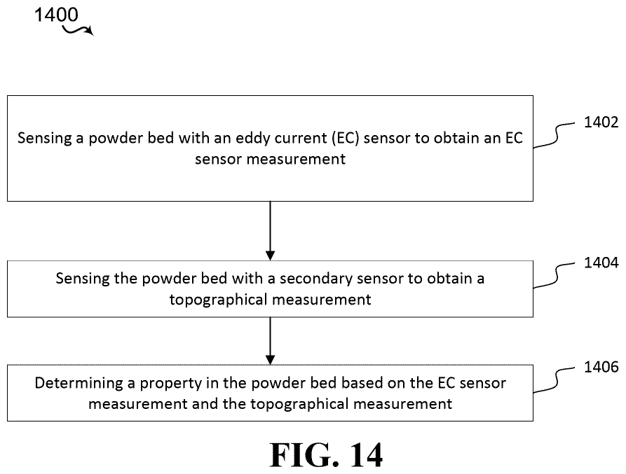

FIG. 14 is a flowchart of a method 1400 showing a method of sensor fusion. At block 1402 the method 1400 includes sensing a powder bed with an eddy current (EC) sensor to obtain an EC sensor measurement. For example, in an aspect at least one processor 152, at least one memory 154, and/or at least one sensor (e.g., EC sensor array 199a) may be configured to or may comprise means for sensing a powder bed 121 (which may include, e.g., sensing build piece 109) to obtain an EC sensor measurement. As used herein, “powder bed” generally includes the powder in the bed, as well as other objects in the bed, such as build pieces (i.e., the fused portions of powder, which may include support structures or other structures that may ultimately be removed from the finished part), and other aspects or characteristics of the bed. Accordingly, “sensing a powder bed” includes sensing powder in the powder bed and/or sensing a build piece in the powder bed and/or sensing other aspects of the powder bed, etc. Similarly, “maintaining a height above the powder bed” includes maintaining a height above the powder, maintaining a height above a build piece, etc.

Sensing at block 1402 can include EC sensor array 199a detecting a selected location of a build piece and/or powder bed 121 and/or build piece 109, which can include taking measurements based on a measurement grid and property estimates, which can be used to generate a table or display as directed and/or controlled by processor(s) 152. Processor(s) 152 can execute instructions stored in memory/memories 154 to move EC sensor array 199a to a selected and/or desired location.

Sensing a powder bed 121 and/or build piece 109 to obtain EC sensor measurements using EC sensor array 199a can be performed in order to generate a first set of measurements that can be used in sensor fusion operation(s) to accurately predict the effect of energy beam application to at least one locations of powder bed 121 and/or build piece 109, which can result in optimized resource utilization (e.g., time and monetary resources consumed during AM build operations) and to fabricate accurate build pieces.

At block 1404, the method 1400 includes sensing the powder bed with at least one secondary sensor(s) 199 (e.g., structural light system(s) 199b, photodiode(s), camera(s), and/or IR camera(s)) to obtain a topographical measurement. For example, in an aspect, topographical measurements can be taken by secondary sensor(s) 199 which can be used to generate a topographical map as directed and/or controlled by processor(s) 152. Processor(s) 152 can execute instructions stored in memory/memories 154 to move secondary sensor(s) 199 and/or direct secondary sensor(s) 199 to a selected and/or desired location.

Sensing a powder bed 121 and/or build piece 109 to obtain topographical measurements using sensor(s) 199 can be performed in order to generate a second set of measurements that can be used in sensor fusion operation(s) to accurately predict the effect of energy beam application to at least one locations of powder bed 121 and/or build piece 109, which can result in optimized resource utilization (e.g., time and monetary resources consumed during AM build operations) and to fabricate accurate build pieces.

At block 1406, the method 1400 includes determining a property in the powder bed and/or build piece based on the EC sensor measurement and the topographical measurement, in other words based on the first set of measurements and the second set of measurements. For example, in an aspect, the EC sensor measurement and topographical measurement can be inputs to at least one algorithm(s) stored in memory/memories 154 directed and/or controlled by processor(s) 152. Processor(s) 152 can execute instructions stored in memory/memories 15, which can be AI/ML algorithms in some aspects, to accurately predict the effect of energy beam application to at least one locations of powder bed 121 and/or build piece 109, which can result in optimized resource utilization (e.g., time and monetary resources consumed during AM build operations) and to fabricate accurate build pieces.

In an alternative or additional aspect, at block 1402 the method 1400 may further include maintaining a height of the EC sensor array 199a above the powder bed. For example, in an aspect, height of the EC sensor array 199a can be maintained via execution of at least one algorithm(s) stored in memory/memories 154 directed and/or controlled by processor(s) 152. Processor(s) 152 can execute instructions stored in memory/memories 154, which can be AI/ML algorithms in some aspects, to accurately maintain height of EC sensor array 199a above powder bed 121 and/or build piece 109 so that measurement accuracy remains high and the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

Additionally or alternatively, the method 1400 may further include determining voltage changes at a plurality of locations of the powder bed 121 and/or build piece 109. For example, in an aspect, measurements taken by the EC sensor array 199a can be compared via execution of at least one algorithm(s) stored in memory/memories 154 directed and/or controlled by processor(s) 152. Processor(s) 152 can execute instructions stored in memory/memories 154, to determine topographical changes in powder bed 121 and/or build piece 109 which can be accounted for and/or remedied, and/or to identify LoF effects in a build piece.

In an alternative or additional aspect, the method 1400 can include determining impedance changes based on the determined voltage changes at the plurality of locations of the powder bed and/or build piece. For example, in an aspect, the voltage changes can be determined according to at least one algorithm(s) stored in memory/memories 154 directed and/or controlled by processor(s) 152. Processor(s) 152 can execute instructions stored in memory/memories 15, which can be AI/ML algorithms in some aspects, to accurately predict the effect of energy beam application to at least one locations of powder bed 121 and/or build piece 109, which can result in optimized resource utilization (e.g., time and monetary resources consumed during AM build operations) and to fabricate accurate build pieces.

In an alternative or additional aspect, sensing at block 1402 can include moving the recoater and/or depositor 101 across the powder bed 121 and/or build piece 109. This can be accomplished by instructions stored in memory/memories 154 that when executed by processor(s) 152 cause the processor(s) 152 to maintain a height of the EC sensor by engaging and/or operating at least one motors and/or other mechanical or electromechanical components that are coupled with the EC sensor array 199a to maintain the EC sensor array 199a at a particular height above the powder bed and/or build piece.

In an alternative or additional aspect, the determining at block 1406 can include performing at least one a statistical analysis or machine learning (AI/ML) operation(s). For example, processor(s) 152 can execute instructions stored in memory/memories 154, which can be statistical analysis and/or AI/ML algorithms in order to determine at least one properties in the powder bed and/or build piece based on inputs including the lift off measurement and/or topographical measurement.

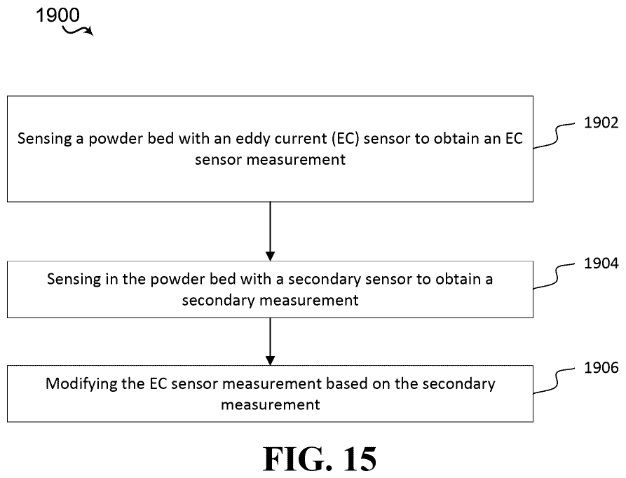

FIG. 15 is a flowchart of a method 1900 showing sensor fusion. At block 1902 the method 1900 includes sensing a powder bed and/or build piece with an eddy current (EC) sensor array to obtain an EC sensor measurement. For example, in an aspect at least one processor 152, at least one memory 154, and/or at least one sensor (e.g., EC sensor array 199a) may be configured to or may comprise means for sensing a powder bed 121 and/or build piece 109 to obtain an EC sensor measurement.

Sensing at block 1902 can include EC sensor array 199a detecting a selected location of powder bed 121 and/or build piece 109, which can include taking EC sensor measurement(s) based on a measurement grid and property estimates, which can be used to generate a table or display as directed and/or controlled by processor(s) 152. Processor(s) 152 can execute instructions stored in memory/memories 154 to move EC sensor array 199a to a selected and/or desired location.

Sensing a powder bed 121 and/or build piece 109 to obtain at least one EC sensor measurements using EC sensor array 199a can be performed in order to generate a first set of EC sensor measurements that can be used in sensor fusion operation(s) to accurately predict the effect of energy beam application to at least one locations of powder bed 121 and/or build piece 109, which can result in optimized resource utilization (e.g., time and monetary resources consumed during AM build operations) and to fabricate accurate build pieces.

At block 1904, the method 1400 includes sensing the powder bed and/or build piece with at least one secondary sensor(s) 199 (e.g., structural light system(s), photodiode(s), camera(s), and/or IR camera(s)) to obtain a secondary measurement. For example, in an aspect, topographical measurements can be taken by secondary sensor(s) 199 which can be used to generate a secondary measurement as directed and/or controlled by processor(s) 152. Processor(s) 152 can execute instructions stored in memory/memories 154 to move secondary sensor(s) 199 and/or direct secondary sensor(s) 199 to a selected and/or desired location.

Sensing a powder bed 121 and/or build piece 109 to obtain topographical measurements using sensor(s) 199 can be performed in order to generate a secondary measurement(s) that can be used in sensor fusion operation(s) to accurately predict the effect of energy beam application to at least one locations of powder bed 121 and/or build piece 109, which can result in optimized resource utilization (e.g., time and monetary resources consumed during AM build operations) and to fabricate accurate build pieces.

At block 1906, the method 1400 includes modifying the EC sensor measurement(s) based on the secondary measurement(s), in other words based on the secondary measurement(s) and/or set of measurements. For example, in an aspect, the secondary measurement(s) can be inputs to at least one algorithm(s) stored in memory/memories 154 directed and/or controlled by processor(s) 152. Processor(s) 152 can execute instructions stored in memory/memories 15, which can be AI/ML algorithms in some aspects, to accurately modify the EC sensor measurement(s). This can be performed in order to accurately predict the effect of energy beam application to at least one locations of powder bed 121 and/or build piece 109, which can result in optimized resource utilization (e.g., time and monetary resources consumed during AM build operations) and to fabricate accurate build pieces.

In an alternative or additional aspect, at block 1906 the method 1900 may further include modifying the EC sensor measurement(s) taken by EC sensor array 199a above the powder bed and/or build piece. For example, in an aspect, calibrating the EC sensor measurement(s) based on the secondary measurement(s) can include execution of at least one algorithm(s) stored in memory/memories 154 directed and/or controlled by processor(s) 152. Processor(s) 152 can execute instructions stored in memory/memories 154, which can be AI/ML algorithms in some aspects, to calibrate the EC sensor measurement so that EC sensor array 199a can have improved accuracy for subsequent measurements so that the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

In an alternative or additional aspect, at block 1906 the method 1900 may further include modifying the EC sensor measurement(s) taken by EC sensor array 199a above the powder bed and/or build piece. For example, in an aspect, calibrating the EC sensor measurement(s) based on the secondary measurement(s) can include execution of at least one algorithm(s) stored in memory/memories 154 directed and/or controlled by processor(s) 152. Processor(s) 152 can execute instructions stored in memory/memories 154, which can be algorithms configured to compare measured stand-off distance distances of EC sensor array 199a to a nominal stand-off distance of the EC sensor array to obtain the comparison so that the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

Alternatively or additionally, the EC sensor measurement(s) can be modified based on the comparison so that EC sensor array 199a can have improved accuracy for subsequent measurements so that the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

In an alternative or additional aspect, the method 1900 can include determining at least one property in the sensor bed based on the modified EC sensor measurement. For example, in an aspect, the property/properties can be determined according to at least one algorithm(s) stored in memory/memories 154 directed and/or controlled by processor(s) 152. Processor(s) 152 can execute instructions stored in memory/memories 15, which can be AI/ML algorithms in some aspects, to accurately predict the effect of energy beam application to at least one locations of powder bed 121 and/or build piece 109, which can result in optimized resource utilization (e.g., time and monetary resources consumed during AM build operations) and to fabricate accurate build pieces.

In an alternative or additional aspect, at block 1902 the method 1900 may further include maintaining a height of the EC sensor array 199a above the powder bed and/or build piece. For example, in an aspect, height of the EC sensor array 199a can be maintained via execution of at least one algorithm(s) stored in memory/memories 154 directed and/or controlled by processor(s) 152. Processor(s) 152 can execute instructions stored in memory/memories 154, which can be AI/ML algorithms in some aspects, to accurately maintain height of EC sensor array 199a above powder bed 121 and/or build piece 109 so that measurement accuracy remains high and the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

Additionally or alternatively, the method 1900 may further include determining voltage changes at a plurality of locations of the powder bed 121 and/or build piece 109. For example, in an aspect, measurements taken by the EC sensor array 199a can be compared via execution of at least one algorithm(s) stored in memory/memories 154 directed and/or controlled by processor(s) 152. Processor(s) 152 can execute instructions stored in memory/memories 154, to determine topographical changes in powder bed 121 and/or build piece 109 which can be accounted for and/or remedied, and/or to identify LoF effects in a build piece.

In an alternative or additional aspect, the method 1900 can include performing at least one a statistical analysis or machine learning (AI/ML) operation(s). For example, processor(s) 152 can execute instructions stored in memory/memories 154, which can be statistical analysis and/or AI/ML algorithms in order to determine at least one properties in the powder bed and/or build piece based on inputs including the lift off measurement and/or topographical measurement.

In an alternative or additional aspect, at block 1904 the method 1900 may further include storing. For example, in an aspect, a secondary measurement can be a temperature or thermal measurement captured or taken by an IR camera 199e. The IR camera 199e can be controlled according to one or more algorithms stored in at least one memory 154 and executed by at least one processor 152. Temperature data can be stored in memory/memories 154.

Processor(s) 152 can execute instructions stored in memory/memories 154, which can be AI/ML algorithms in some aspects, to correlate EC sensor array measurement(s) with the temperature data.

At least one sensor calibration model can be generated based on the correlation and according to instructions stored in memory/memories 154 and executed by processor(s) 152 so that measurement accuracy remains high and the effect of energy beam application to at least one locations of powder bed 121 and/or build piece 109 is standardized and/or optimized, which can result in optimized resource utilization (e.g., time and monetary resources consumed during AM build operations) and to fabricate accurate build pieces.

In an alternative or additional aspect, at block 1904 the method 1900 may further include correlating voltage data with temperature data. For example, in an aspect, EC sensor measurement(s) taken or captured by an EC sensor array 199a can include voltage data and secondary measurement(s) can be temperature or thermal measurement(s) captured or taken by an IR camera 199e. The IR camera 199e can be controlled according to one or more algorithms stored in at least one memory 154 and executed by at least one processor 152. Correlation of voltage data with temperature data can occur via execution of at least one algorithm(s) stored in memory/memories 154 directed and/or controlled by processor(s) 152, which can be AI/ML algorithms in some aspects.

In an alternative or additional aspect, at block 1902 the method 1900 may further include sensing on a build axis of the additive manufacturing process. For example, in an aspect, a sensor 199 can be an on-axis sensor of an energy beam. Sensing can occur via execution of at least one algorithm(s) stored in memory/memories 154 directed and/or controlled by processor(s) 152, which can be AI/ML algorithms in some aspects.

In an alternative or additional aspect, at block 1902 the method 1900 may further include sensing off a build axis of the additive manufacturing process. For example, in an aspect, a sensor 199 can be an off-axis sensor that is off a beam axis of an energy beam. Sensing can occur via execution of at least one algorithm(s) stored in memory/memories 154 directed and/or controlled by processor(s) 152, which can be AI/ML algorithms in some aspects.

In an alternative or additional aspect, at block 1902 the method 1900 may further include sensing at least one layer below a surface layer of the powder bed 121 and/or build piece 109. For example, in an aspect, a sensor 199 can be a sensor with subsurface sensing ability, such as an EC sensor array 199a. Sensing can occur via execution of at least one algorithm(s) stored in memory/memories 154 directed and/or controlled by processor(s) 152, which can be AI/ML algorithms in some aspects.

In an alternative or additional aspect, the method 1900 may further include performing, via the at least one processor 152 of the correlating subsystem, a machine learning process.

In an alternative or additional aspect, the method 1900 may further include predicting, via a prediction subsystem and using at least one processor 152, at least one lack of fusion defect based on the machine learning process.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming but would nevertheless be a routine undertaking of engineering for those of ordinary skill in the art, having the benefit of this disclosure. Elements shown in dashed lines in the figures should be considered optional in various aspects.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

In yet another variation, aspects of the present disclosure may be implemented using a combination of both hardware and software.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Further, the word “example” is used herein to mean “serving as an example, instance, or illustration.” Any aspect described herein as “example” is not necessarily to be construed as preferred or advantageous over other aspects. Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. Nothing disclosed herein is intended to be dedicated to the public regardless of whether such disclosure is explicitly recited in the claims.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computer system 150. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of at least one programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some aspects, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system (such as the one described in greater detail in FIG. 1E, above). Accordingly, each module may be realized in a variety of suitable configurations and should not be limited to any particular implementation exemplified herein.

What is claimed is:

1. A method for powder bed additive manufacturing, comprising:
sensing a powder bed with an eddy current (EC) sensor to obtain an EC sensor measurement;
sensing the powder bed with a secondary sensor to obtain a topographical measurement; and
determining a property in the powder bed based on the EC sensor measurement and the topographical measurement.

2. The method of claim 1, wherein the property includes a defect in the powder bed.

3. The method of claim 2, wherein the defect includes a lack of fusion (LoF) defect of a build piece in the powder bed.

4. The method of claim 1, wherein sensing the powder bed with the EC sensor further comprises:
maintaining a height of the EC sensor above the powder bed; and
determining voltage changes at a plurality of locations of the powder bed.

5. The method of claim 4, further comprising:
determining impedance changes based on the determined voltage changes at the plurality of locations of the powder bed.

6. The method of claim 4, wherein the EC sensor is mounted on a recoater and sensing the powder bed with the EC sensor further comprises:
moving the recoater across the powder bed.

7. The method of claim 1, wherein the secondary sensor comprises a light sensor.

8. The method of claim 7, wherein the light sensor comprises a structural light sensor, and the topographical measurement comprises a point cloud acquired at least in part from the structural light.

9. The method of claim 8, wherein the structural light sensor comprises at least one camera and a projector.

10. The method of claim 1, wherein determining the property in the powder bed comprises performing at least a statistical analysis or machine learning.

11. A system for powder bed additive manufacturing, comprising:
an eddy current (EC) sensor array configured to obtain an EC sensor measurement;
a secondary sensing subsystem configured to sense a powder bed to obtain a topographical measurement; and
at least one processor; and
at least one memory,
wherein the at least one memory stores instructions that, when executed by the at least one processor, cause the at least one processor to determine a property in the powder bed based on the EC sensor measurement and the topographical measurement.

12. The system of claim 11, wherein the property includes a defect in the powder bed.

13. The system of claim 12, wherein the defect includes a lack of fusion (LoF) defect of a build piece in the powder bed.

14. The system of claim 11, wherein the eddy current sensor array is further configured to:
maintain a height above the powder bed; and
sense voltage changes at a plurality of locations of the powder bed.

15. The system of claim 14, wherein the instructions further cause the at least one processor to determine impedance changes based on the sensed voltage changes at the plurality of locations of the powder bed.

16. The system of claim 14, wherein the EC sensor is mounted on a recoater configured to move across the powder bed.

17. The system of claim 11, wherein the secondary sensing subsystem comprises a light sensor.

18. The system of claim 17, wherein the light sensor comprises a structural light sensor, and wherein the topographical measurement further comprises a point cloud acquired at least in part from the structural light.

19. The system of claim 18, wherein the structural light sensor at least one camera and a projector.

20. The system of claim 11, wherein determining the property in the powder bed comprises performing at least a statistical analysis or machine learning.

21. A method for powder bed additive manufacturing, comprising:
sensing in a powder bed with an eddy current (EC) sensor to obtain an EC sensor measurement;
sensing in the powder bed with a secondary sensor to obtain a secondary measurement; and
modifying the EC sensor measurement based on the secondary measurement.

22. The method of claim 21, further comprising:
determining a property in the powder bed based on the modified EC sensor measurement.

23. The method of claim 22, wherein the property includes a defect in the powder bed.

24. The method of claim 23, wherein the defect includes a lack of fusion (LoF) defect of a build piece in the powder bed.

25. The method of claim 21, wherein sensing in the powder bed with the EC sensor further comprises:
maintaining a height of the EC sensor above the powder bed; and
determining voltage changes at a plurality of locations of the powder bed.

26. The method of claim 25, further comprising:
determining impedance changes based on the determined voltage changes at the plurality of locations of the powder bed.

27. The method of claim 25, wherein the EC sensor is mounted on a recoater and sensing in the powder bed with the EC sensor further comprises:
moving the recoater across the powder bed.

28. The method of claim 21, wherein the secondary sensor comprises a light sensor.

29. The method of claim 28, wherein the light sensor comprises a structural light sensor, and the secondary measurement comprises a point cloud acquired at least in part from the structural light.

30. The method of claim 29, wherein the structural light sensor comprises at least one cameras and a projector.

31. The method of claim 21, wherein the EC sensor measurement includes an EC sensor measurement, the secondary measurement includes a topographical measurement, and modifying the EC sensor measurement comprises calibrating the EC sensor measurement based on the topographical measurement.

32. The method of claim 31, wherein the topographical measurement includes a measured stand-off distance, and modifying the EC sensor measurement comprises:
comparing the measured stand-off distance to a nominal stand-off distance of the EC sensor to obtain a comparison; and
modifying the EC sensor measurement based on the comparison.

33. The method of claim 21, wherein the EC sensor measurement includes an EC sensor measurement, and the modified EC sensor measurement includes a modified EC sensor measurement.

34. The method of claim 21, wherein the EC sensor measurement includes a voltage measurement, and the modified EC sensor measurement includes a modified voltage measurement.

35. The method of claim 21, wherein the secondary sensor comprises a thermal sensor, and the secondary measurement comprises a thermal measurement.

36. The method of claim 35, wherein the thermal measurement comprises temperature data, and sensing in the powder bed with the thermal sensor comprises:
storing the temperature data in memory;
correlating the EC sensor measurement with the temperature data; and
generating a sensor calibration model based on the correlation.

37. The method of claim 36, wherein the EC sensor measurement comprises voltage data, and correlating the EC sensor measurement comprises correlating the voltage data with the temperature data.

38. The method of claim 35, wherein sensing in the powder bed with the thermal sensor comprises sensing on a build axis of an additive manufacturing process.

39. The method of claim 38, wherein the thermal sensor comprises a photodiode.

40. The method of claim 35, wherein sensing in the powder bed with the thermal sensor comprises sensing off a build axis of an additive manufacturing process.

41. The method of claim 40, wherein the thermal sensor comprises an infrared camera.

42. The method of claim 36, wherein correlating the EC sensor measurement further comprises:
performing a machine learning process.

43. The method of claim 42, further comprising:
predicting at least one lack of fusion (LoF) defects based on the machine learning process.

44. The method of claim 21, wherein sensing in the powder bed with the EC sensor comprises sensing at least one layers below a surface layer of the powder bed.

45. A system for calibrating an eddy current (EC) sensor array for monitoring a powder bed during an additive manufacturing, comprising:
a first sensing subsystem, comprising:
at least one eddy current (EC) sensor arrays;
a second sensing subsystem; and
a correlating subsystem, comprising:
at least one processor,
wherein EC sensor measurements captured by the first sensing subsystem and a topographical map generated by the second sensing subsystem are correlated by at least one processor of the correlating subsystem and used to calibrate at least one sensor of the EC sensor array.

46. The system of claim 45, wherein the at least one processor of the correlating subsystem estimate at least one properties of the powder bed based on the correlation of the EC sensor measurements and the topographical map.

47. The system of claim 46, wherein the at least one properties include conductivity, defects, and variations in material composition.

48. The system of claim 45, wherein the EC sensor measurements include voltage differences at locations of the powder bed.

49. The system of claim 48, wherein impedance changes are inferred by the correlating subsystem based on the voltage differences at a plurality of locations of the powder bed.

50. The system of claim 45, wherein the EC sensor array is mounted on a recoater.

51. The system of claim 45, wherein the second sensing subsystem comprises a structural light and wherein the topographical map comprises a point cloud acquired at least in part from the structural light.

52. The system of claim 51, wherein the structural light comprises:
at least one cameras; and
a projector.

53. The system of claim 45, wherein the at least one processors of the correlating subsystem are configured to perform at least structural analysis or machine learning during the correlation of the EC sensor measurements and the topographical map.

54. The system of claim 53, wherein the at least one processors of the correlating subsystem are configured to predict defects at a higher rate than would be predicted alone by analysis of the EC sensor measurements or the topographical map.

55. A sensor fusion system for additive manufacturing (AM), comprising:
an eddy current (EC) sensor configured to sense in a powder bed to obtain an EC sensor measurement;
a secondary sensor configured to sense in a powder to obtain a secondary measurement;
at least one processor; anda
at least one memory storing instructions that, when executed by the at least one processor, cause the processor to modify the EC sensor measurement based on the secondary measurement.

56. The sensor fusion system of claim 55, wherein the instructions further cause the processor to determine a property in the powder bed based on the modified EC sensor measurement.

57. The sensor fusion system of claim 56, wherein the property includes a defect in the powder bed.

58. The sensor fusion system of claim 57, wherein the defect includes a lack of fusion (LoF) defect of a build piece in the powder bed.

59. The sensor fusion system of claim 55, wherein sensing in the powder bed with the EC sensor further comprises:
maintaining a height of the EC sensor above the powder bed; and
determining voltage changes at a plurality of locations of the powder bed.
